(19) United States
(12) Patent Application Publication
(10) Pub. No.: US 2009/0122947 A1
(43) Pub. Date: May 14, 2009

(54) Joining Structure Between Top Nozzle and Guide Thimbles In Nuclear Fuel Assembly

(75) Inventors: Nam-Gyu PARK, Daejeon (KR); Kyu-Tae Kim, Daejeon (KR); Jung-Min Suh, Daejeon (KR); Shin-Ho Lee, Daejeon (KR); Kyong-Bo Eom, Daejeon (KR); Joon-Kyoo Park, Daejeon (KR); Jin-Sun Kim, Daejeon (KR); Gyu-Cheol Shin, Daejeon (KR); Seong-Ki Lee, Daejeon (KR); Il-kyu Kim, Daejeon (KR); Ki-Sung Choi, Daejeon (KR); Kyeong-Lak Jeon, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: Korea Nuclear Fuel Co.,Ltd, Daejeon (KR)

(21) Appl. No.: 12/187,455

(22) Filed: Aug. 7, 2008

(30) Foreign Application Priority Data
Aug. 27, 2007 (KR) 10-2007-0086066
Mar. 14, 2008 (KR) 10-2008-0024071

(51) Int. Cl. G21C 3/32

(52) U.S. Cl. 376/446

(57) ABSTRACT

Disclosed herein is a joining structure between a top nozzle and guide thimbles in a nuclear fuel assembly, which can prevent a rotation of inner insertion tube bodies when the top nozzle is separated from the nuclear fuel assembly and promote convenience in assembling and disassembling the top nozzle and the guide thimbles.

This is a non-provisional application under 35 U.S.C. § 1.111(a) which claims priority from Korean patent application 10-2007-0086066 filed on Aug. 27, 2007, and from Korean patent application 10-2008-0024071 filed Mar. 14, 2008, all of which are incorporated herein by reference.

### BACKGROUND OF THE INVENTION

1. Field of the Invention

The present invention relates to a joining structure between a top nozzle and guide thimbles in a nuclear fuel assembly, and more particularly, to a joining structure between a top nozzle and guide thimbles in a nuclear fuel assembly, which can prevent a rotation of inner insertion tube bodies when the top nozzle is separated from the nuclear fuel assembly and promote convenience in assembling and disassembling the top nozzle and the guide thimbles.

2. Background Art

A nuclear reactor refers to a device that is designed to artificially control the chain reaction of the nuclear fission of fissile materials, thereby achieving a variety of use purposes such as the generation of heat, the production of radioisotopes and plutonium, the formation of radiation fields, or the like.

Generally, enriched uranium that is obtained by raising a ratio of uranium-235 to a range between 2% and 5% is used in a light water nuclear reactor. The uranium is molded to a cylindrical pellet having a weight of 5 g so as to be processed to a nuclear fuel used in the nuclear reactor. Numerous pellets are embedded into a cladding tube made of Zircaloy being at a vacuum state. Thereafter, a spring and a helium gas are put thereinto, and then a top end closure stopper is welded thereon, thereby making a fuel rod. The fuel rod is finally surrounded by a nuclear fuel assembly and then burnt up within the nuclear reactor through nuclear reaction.

FIG. 1 is a schematic view showing a general nuclear fuel assembly.

Referring to FIG. 1, the nuclear fuel assembly includes a skeleton comprised of a top nozzle 4, a bottom nozzle 5, a plurality of spacer grids 2, guide thimbles 3 and a metering tube 6, and a plurality of fuel rods 1 inserted longitudinally into an organized array by the spacer grids 2 in such a manner as to be supported by means of springs (not shown) and dimples (not shown) disposed within the spacer grids 2. In order to prevent the formation of scratches on the fuel rods 1 and the generation of damage on the springs upon assembling the nuclear fuel assembly, the fuel rods 1 have a locker applied thereon and are then inserted longitudinally into the skeleton of the nuclear fuel assembly. Next, the top and bottom nozzles are secured to the opposite ends of the nuclear fuel assembly, thereby finishing the assembling procedure of the nuclear fuel assembly. Then, after the locker of the finished assembly is removed, the distances between the fuel rods 1, the distortion of the nuclear fuel assembly, the total length thereof, and the dimension thereof are checked out, thereby finishing the manufacturing procedure of the nuclear fuel assembly.

As shown in FIG. 2, the top nozzle 4 includes a hold-down plate 42, hold-down springs 43, inner insertion tubes 45, outer guide-tubular sleeves 44, and a flow plate 41.

Referring to FIGS. 1 and 2, each of the inner insertion tubes 45 of the top nozzle 4 is connected with each of the guide thimbles 3, thereby firmly fixing the nuclear fuel assembly in the reactor and ensuring the structural stability during the burn-up of the nuclear fuel.

In the meantime, the top nozzle 4 and the guide thimbles 3 are joined with each other in such a way as to be removably connected to each other, thereby ensuring a channel to draw out the fuel rods 1 by disassembling the top nozzle 4. When a worker performs a removing work of the top nozzle 4 within a storage tank, the removing work must be performed remotely to minimize damage by radioactivity. Accordingly, the joining structure between the top nozzle 4 and the guide thimbles 3 must be designed in such a way that they are removed from each other and joined with each other remotely.

FIGS. 2 and 3 illustrate a method of joining the guide thimbles 3 with the top nozzle 4 in the nuclear fuel assembly. Referring to the drawings, the joining method of the guide thimbles 3 and the top nozzle 4 will be described. A male screw is formed on a lower end portion 451 of each inner insertion tube 45 as shown in FIG. 2, and a female screw 31 is formed on an inner surface of an upper portion of a guide thimble flange welded to each of the guide thimbles as shown in FIG. 3, whereby the top nozzle 4 and the guide thimbles 3 are joined with each other by screw-joining.

That is, the top nozzle 4 and the guide thimbles 3 are joined with each other through joining of the guide thimbles 3 and the inner insertion tubes 45.

Each of the outer guide-tubular sleeves 44 has a male screw formed on a lower portion thereof so as to be screw-coupled with the flow plate 41. The spiral end portion of the outer guide-tubular sleeve 44 is locally welded with the flow plate 41 to prevent a rotation of the outer guide-tubular sleeve 44. Furthermore, in order to prevent the loosening of each inner insertion tube 45, a head of the inner insertion tube 45 is locally crimped in a radius direction in such a way as to be in contact with the outer guide-tubular sleeve 44. Moreover, the inner insertion pipe 45 can be separated from the outer guide-tubular sleeve 44 only when a torque of more than a specific power is applied to the head.

However, in the state where the inner insertion pipe 45 is joined with the outer guide-tubular sleeve 44, when the inner insertion tube 45 of the top nozzle 4 is rotated to be separated from the outer guide-tubular sleeve 44, since a distance between an outer face of the inner insertion tube 45 and an inner face of the outer guide-tubular sleeve 44 is too short, it is difficult that the screw is rotated if concentricity is not congruous or foreign matters are inserted and stuck between the outer face and the inner face. That is, due to a friction heat generated by a contact face, the inner insertion tubes 45 and the outer guide-tubular sleeves 44, which are made of stainless steel, are fused together through a cold welding effect, and hence, screw loosening does not occur.

In order to solve the above-mentioned problems, there have been disclosed U.S. Pat. No. 4,702,883 entitled “A reconstitutable fuel assembly having removable upper stops on guide thimbles”, and U.S. Pat. No. 4,687,630 entitled “A top nozzle and guide thimble joint structure in a nuclear fuel assembly”.

In the prior arts, heads of outer guide-tubular sleeves are removed without any inner insertion tube, and processed to have screws so as to minimize a contact face when the outer guide-tubular sleeves are removed. That is, joining portions are formed on a male screw portion of a lower portion of each outer guide-tubular sleeve and on a female screw portion of a lower portion of each of guide thimbles, and each of the outer guide-tubular sleeves additionally has a screw-joining portion formed on an upper portion thereof.

Accordingly, when the head screw of each outer guide-tubular sleeve is rotated to remove the top nozzle, since the outer guide-tubular sleeve and the head thereof are screw-coupled with each other, the screw-joining between the outer guide-tubular sleeve and the guide thimble may be loosened. Hence, in order to prevent the screw loosening at the lower portion of the outer guide-tubular sleeve, the outer guide-tubular sleeve is equipped with a wedge device, but it has a problem in that the assembling and disassembling processes are complicated.

### SUMMARY OF THE INVENTION

Accordingly, the present invention has been made in an effort to solve the above-mentioned problems occurring in the prior arts, and it is an object of the present invention to provide a joining structure between a top nozzle and guide thimbles in a nuclear fuel assembly, in which inner insertion tube bodies are not separated from the guide thimbles when inner insertion tube heads are removed from the inner insertion tube bodies to separate the top nozzle from the nuclear fuel assembly in a state where the inner insertion tube heads are screw-coupled with the inner insertion tube bodies.

It is another object of the present invention to provide a joining structure between a top nozzle and guide thimbles in a nuclear fuel assembly, which includes a screw introduction portion or a screw guide portion disposed at a portion where each of the inner insertion tube heads and each of the inner insertion tube bodies are joined with each other, thereby easily assembling and disassembling the top nozzle of the nuclear fuel assembly remotely without any exposure to radioactivity.

To accomplish the above object, according to the present invention, there is provided a joining structure between a top nozzle and guide thimbles in a nuclear fuel assembly comprising: a guide thimble flange joined between an upper portion of each of the guide thimbles of the nuclear fuel assembly and a lower portion of the top nozzle; the top nozzle including: a flow plate located above the guide thimble flanges and having a through-hole; outer guide-tubular sleeves, each of whose lower portion is joined to the through-hole of the flow plate; inner insertion tube bodies each adapted to be inserted into each outer guide-tubular sleeve, each of whose lower end portion protruding from a lower portion of the flow plate and being joined with each guide thimble flange; and inner insertion tube heads each adapted to be connected to upper end portions of each inner insertion tube body and each outer guide-tubular sleeve to thereby connect the inner insertion tube body and the outer guide-tubular sleeve with each other; and rotation-preventing means disposed at a connected portion between the inner insertion tube body and the through-hole of the flow plate.

Each of the guide thimble flanges may be connected with an upper portion of each of the guide thimbles of the nuclear fuel assembly through welding.

The rotation-preventing means includes: rotation-preventing face portions formed on a portion of an outer circumferential surface of the inner insertion tube body in such a way as to flatten at least two faces; and a rotation-preventing retaining jaw portion formed on an inner circumferential surface of the through-hole of the flow plate in such a way as to correspond to the rotation-preventing face portion.

The rotation-preventing means further includes a guide portion disposed between the rotation-preventing face portions to prevent interference when fuel rods are inserted longitudinally into or drawn out from the nuclear fuel assembly.

The present invention further includes: a screw introduction portion extending from a lower end of the inner insertion tube head and having a larger inner diameter than other portions of the inner insertion tube head; and a screw guide portion extending from an upper end of the inner insertion tube body and having a smaller outer diameter than other portions of the inner insertion tube body.

As another form, the rotation-preventing means includes: at least one rotation-preventing projection formed on a portion of the outer circumferential surface of the inner insertion tube body; and at least one rotation-preventing recess formed on the inner circumferential surface of the through-hole of the flow plate in such a way as to correspond to the rotation-preventing projection to allow the rotation-preventing projection to be joined thereto.

Also the joining structure between the top nozzle and the guide thimbles in the nuclear fuel assembly having the rotation-preventing means of the above form may further include: a screw introduction portion extending from a lower end of the inner insertion tube head and having a larger inner diameter than other portions of the inner insertion tube head; and a screw guide portion extending from an upper end of the inner insertion tube body and having a smaller outer diameter than other portions of the inner insertion tube body.

In another aspect of the present invention, the present invention provides a joining structure between a top nozzle and guide thimbles in a nuclear fuel assembly comprising:

a guide thimble flange joined with an upper portion of each of the guide thimbles of the nuclear fuel assembly and having a retaining jaw receiving portion; and

the top nozzle comprising: a flow plate located above the guide thimble flanges and having a through-hole; outer guide-tubular sleeves, each of whose lower portion is joined to the through-hole of the flow plate; inner insertion tube bodies each adapted to be inserted into each outer guide-tubular sleeve, each of whose lower end portion protruding from a lower portion of the flow plate and being joined with each guide thimble flange; inner insertion tube heads each adapted to be connected to upper end portions of each inner insertion tube body and each outer guide-tubular sleeve to thereby connect the inner insertion tube body and the outer guide-tubular sleeve with each other; and wedges each adapted to be joined to a lower portion of the flow plate and the inner insertion tube body, each of the wedges having at least one retaining jaw extending from a portion of a lower end thereof and joined with each of the guide thimble flanges in such a way as to be received in the retaining jaw receiving portion of the guide thimble flange.

Furthermore, the joining structure further includes: a screw introduction portion extending from a lower end of the inner insertion tube head and having a larger inner diameter than other portions of the inner insertion tube head; and a screw guide portion extending from an upper end of the inner insertion tube body and having a smaller outer diameter than other portions of the inner insertion tube body.

In addition, the joining structure further includes: rotation-preventing means including: rotation-preventing face portions formed on a portion of an outer circumferential surface of the inner insertion tube body in such a way as to flatten at least two faces; and a rotation-preventing retaining jaw portion formed on an inner circumferential surface of the through-hole of the flow plate in such a way as to correspond to the rotation-preventing face portion.

Accordingly, the present invention can prevent that a joining between each inner insertion tube and each guide thimble is removed by a rotation of the inner insertion tube when the top nozzle is separated from the nuclear fuel assembly since the rotation-preventing means is formed on the inner insertion tube and the flow plate of the top nozzle.

Furthermore, the present invention can allow a worker to easily assemble and disassemble the top nozzle remotely and reduce assembling and disassembling time periods since the screw introduction portion and the screw guide portion adapted to make a screw-coupling easy are disposed on the inner insertion tube head and the inner insertion tube body.

Moreover, the present invention can prevent that a joining between each inner insertion tube and each guide thimble is removed by a rotation of the inner insertion tube when the top nozzle is separated from the nuclear fuel assembly since the wedge is disposed at the connected portion between the inner insertion tube body of the top nozzle and the guide thimble flange.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view of a typical nuclear fuel assembly;

FIG. 2 is a partially sectional view of a conventional top nozzle;

FIG. 3 is a sectional view of a typical guide thimble;

FIG. 4 is a perspective view, in section, showing a state where a top nozzle and a guide thimble flange are joined with each other according to a first preferred embodiment of the present invention;

FIG. 5 is a perspective view of an outer guide-tubular sleeve, the top nozzle, and a main body of an inner insertion tube according to the first preferred embodiment of the present invention;

FIG. 6 is a perspective view, in section, of the outer guide-tubular sleeve according to the first preferred embodiment of the present invention;

FIG. 7 is a sectional view of the main body and a head of the inner insertion tube according to the first preferred embodiment of the present invention;

FIG. 8 is a bottom view showing a state where a main body of an inner insertion tube and a flow plate are joined with each other according to a second preferred embodiment of the present invention;

FIG. 9 is a bottom view showing a state where a main body of an inner insertion tube and a flow plate are joined with each other according to a third preferred embodiment of the present invention;

FIG. 10 is a perspective view, in section, of the flow plate according to the second and third preferred embodiments of the present invention;

FIG. 11 is a perspective view of a main body of an inner insertion tube according to a fourth preferred embodiment of the present invention.

FIG. 12 is a perspective view, in section, of a flow plate according to the fourth preferred embodiment of the present invention;

FIG. 13 is a perspective view, in section, showing a state where a top nozzle and a guide thimble flange are joined with each other according to a fifth preferred embodiment of the present invention; and

FIG. 14 is a perspective view of a wedge and the guide thimble flange according to the fifth preferred embodiment of the present invention.

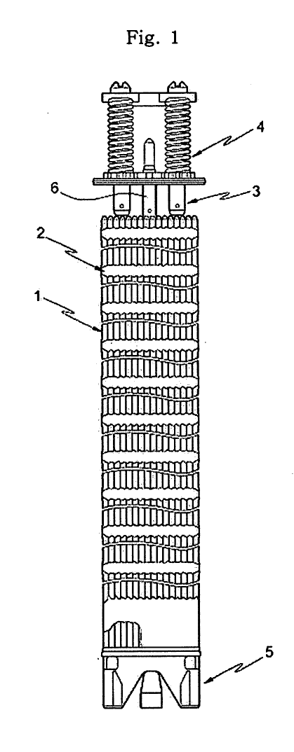

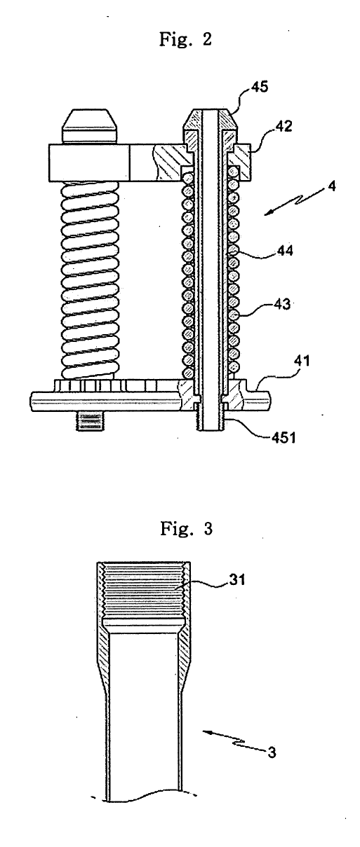

### DETAILED DESCRIPTION OF THE PREFERRED EMBODIMENT

Reference will be now made in detail to the preferred embodiment of the present invention with reference to the attached drawings. In the drawings, while components having the same roles and constructions have the same reference numerals, components having different roles and constructions have different reference numerals.

A joining structure between a top nozzle and guide thimbles according to the present invention basically includes guide thimble flanges 30 and the top nozzle having outer guide-tubular sleeves 120, inner insertion tubes 150, a flow plate 160, and wedges 70. Each of the inner insertion tubes 150 includes an inner insertion tube head 140 and an inner insertion tube body 130.

Rotation-preventing means for preventing a rotation of the inner insertion tube body 130 when the inner insertion tube head 140 is rotated is disposed at a connected portion between the inner insertion tube body 130 and the flow plate 120.

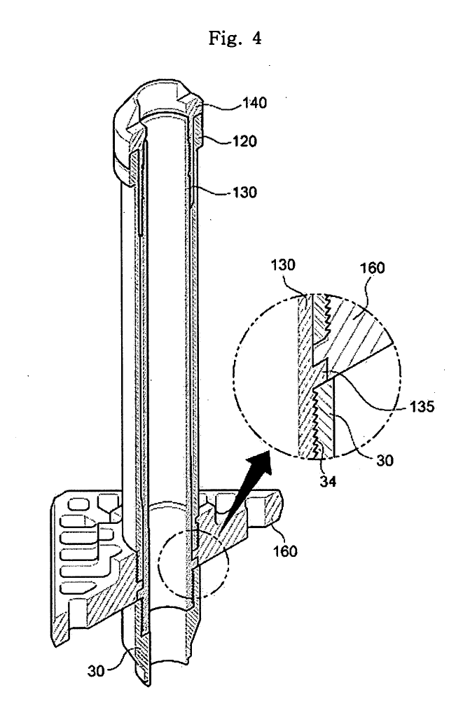

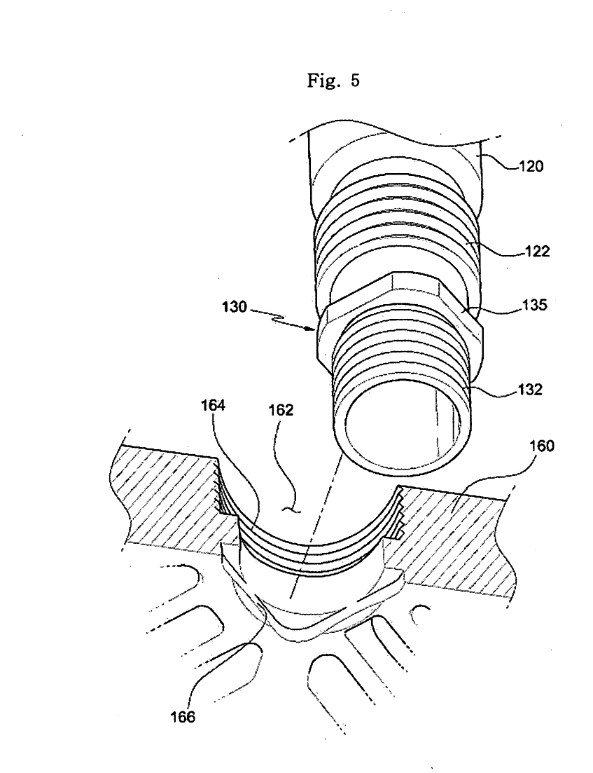

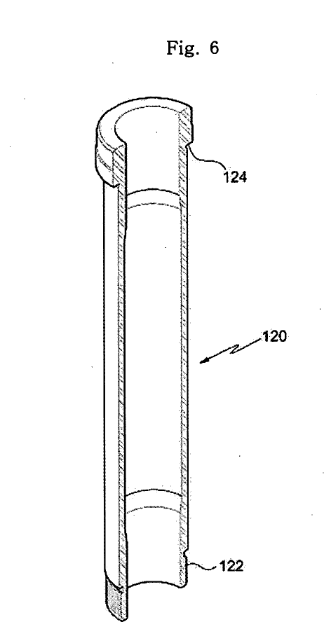

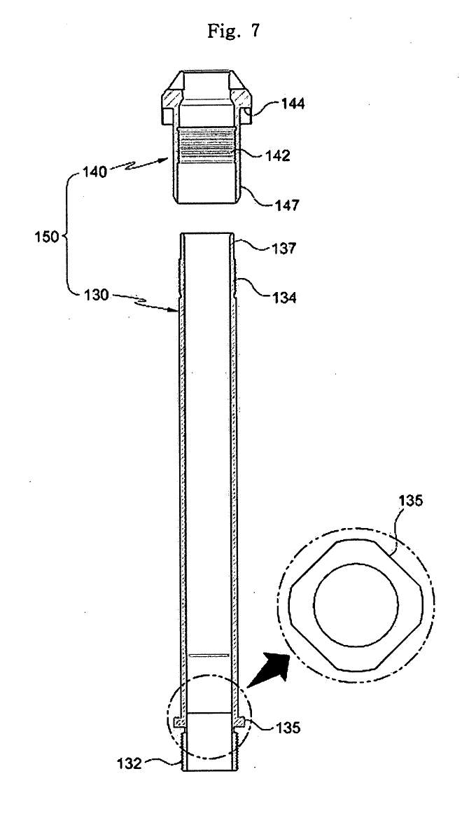

FIGS. 4 to 7 are views showing a joining structure between the top nozzle and the guide thimbles in a nuclear fuel assembly according to a first preferred embodiment of the present invention, wherein FIG. 4 is a perspective view, in section, showing a state where the top nozzle and each of the guide thimbles are joined with each other, FIG. 5 is a perspective view of each outer guide-tubular sleeve 120, each inner insertion tube body 130 and the flow plate 160, FIG. 6 is a perspective view, in section, of the outer guide-tubular sleeve 120, and FIG. 7 is a sectional view of the inner insertion tube body and the inner insertion tube head.

FIG. 4 illustrates a state where the outer guide-tubular sleeve 120, the inner insertion tube body 130, the inner insertion tube head 140, the flow plate 160 and the guide thimble flange 30 are joined together.

The outer guide-tubular sleeve 120 is joined with the flow plate 160 through a screw-coupling, and the inner insertion tube body 130 is located inside the outer guide-tubular sleeve 120. A lower end portion of the inner insertion tube body 130 perforates the flow plate 160 and protrudes outwardly from the flow plate 160. Each of the guide thimble flanges 30 is joined to the lower end portion of each protruding inner insertion tube body 130. The inner insertion tube head 140 connects and joins the inner insertion tube body 130 and the outer guide-tubular sleeve 120 together.

FIG. 5 is a perspective view, in section, showing a state where the outer guide-tubular sleeve 120, the inner insertion tube body 130 and the flow plate 160 are joined together.

The inner insertion tube body 130 is located inside the outer guide-tubular sleeve 120, and the outer guide-tubular sleeve 120 has a male screw 122 formed on an outer circumferential surface of a lower end portion thereof in such a way as to be firmly coupled with a female screw 164 of the flow plate 160.

The inner insertion tube body 130 includes: a lower male screw 132 formed on an outer circumferential surface of the lower end portion protruding from a through-hole 162 of the flow plate 160, the lower male screw 132 being screw-coupled with the guide thimble flange 30; and a rotation-preventing face portion 135 formed above the lower male screw 132 and abutting against a rotation-preventing retaining jaw portion 166 of the flow plate 160.

Referring to FIGS. 6 and 7, features of the components will be described in detail.

As shown in FIG. 6, in the first preferred embodiment, the outer guide-tubular sleeve 120 is formed of a hollow cylinder and opened at an upper face and a lower face thereof, and has the male screw 122 formed on the outer circumferential surface of the lower end portion thereof to promote the coupling with the flow plate 160.

An outer circumference of an upper end portion of the outer guide-tubular sleeve 120 has a larger diameter than other portions of the outer guide-tubular sleeve 120, so that the outer guide-tubular sleeve 120 can be joined with a hold-down plate (not shown) by means of a retaining jaw 124 formed due to a difference in diameter.

As shown in FIG. 7, the inner insertion tube 150 according to the first preferred embodiment includes the inner insertion tube body 130 and the inner insertion tube head 140.

The inner insertion tube body 130 is formed of a hollow cylinder and opened at an upper face and a lower face thereof like the outer guide-tubular sleeve 120. Furthermore, the inner insertion tube body 130 is longer and smaller in diameter than the outer guide-tubular sleeve 120, and hence, when it is inserted into the outer guide-tubular sleeve 120, while its upper portion is of even height with the outer guide-tubular sleeve 120, its lower portion protrudes outwardly from the outer guide-tubular sleeve 120.

The lower portion of the inner insertion tube body 130 protruding from the outer guide-tubular sleeve 120 includes the lower male screw 132 screw-coupled with the guide thimble flange 30, and the upper portion of the inner insertion tube body 130 includes an upper male screw 134 to be joined with the inner insertion tube head 140.

The rotation-preventing face portion 135 is formed above the lower male screw 132 of the inner insertion tube body 130 to prevent the rotation of the inner insertion tube body 130 when the inner insertion tube head 140 is rotated to separate the joined top nozzle 4 from the nuclear fuel assembly.

The rotation-preventing face portion 135 protrudes outwardly since it has a larger diameter than other portions of the inner insertion tube body 130. That is, the rotation-preventing face portion 135 protrudes outwardly in an annular flange form, and a part of the protruding outer circumferential surface is cut and flattened in such a way as to have flat faces. In the first preferred embodiment, the rotation-preventing face portion 135 is formed of a rectangular shape having four rounded edges and four sides.

In addition, a screw guide portion 137 is formed above the upper male screw 134 of the inner insertion tube body 130. The screw guide portion 137 has a smaller outer diameter than other portions of the inner insertion tube body 130 so as to be easily joined with the inner insertion tube head 140.

The inner insertion tube head 140 is opened at its upper and lower faces and constructed of a perforated form. The upper portion of the inner insertion tube body 130 is inserted into and screw-coupled with the inner insertion tube head 140. The inner insertion tube head 140 is constructed of a double wall form in such a way as to cover an upper portion of the outer guide-tubular sleeve 120.

That is, the inner insertion tube head 140 is larger in inner diameter than the inner insertion tube body 130 and has a female screw 142 formed on an inner circumferential surface thereof, so that the upper male screw 134 of the inner insertion tube body 130 can be coupled thereto.

Moreover, the inner insertion tube head 140 has an outer diameter equal to or larger than a diameter of the outer guide-tubular sleeve 120, and includes a retaining jaw 144 for restraining the outer guide-tubular sleeve 120.

The outer circumference of the inner insertion tube head 140 joined with the outer guide-tubular sleeve 120 and having the retaining jaw 144 is constructed of a membrane structure and crimped and joined to the outer guide-tubular sleeve 120.

Furthermore, a screw introduction portion 147 is formed beneath the female screw 142 of the inner insertion tube head 140. Since the screw introduction portion 147 is larger in inner diameter than other portions of the inner insertion tube head 140, so that an upper end of the inner insertion tube body 130 can be easily inserted into the inner insertion tube head 140 to thereby be coupled with the inner insertion tube head 140.

The flow plate 160 according to the first preferred embodiment includes the through-hole 162, to which the outer guide-tubular sleeve 120 is joined, and through which the inner insertion tube body 130 penetrates.

The through-hole 162 has a female screw 164, which will be screw-coupled with the male screw 122 of the outer guide-tubular sleeve 120.

The female screw 164 has a stepped jaw formed along a lower circumference thereof, and the stepped jaw is caught and joined to an upper portion of the protruding outer circumferential face including the rotation-preventing face portion 135 of the inner insertion tube body 130.

The stepped jaw has the rotation-preventing retaining jaw portion 166 disposed of a lower portion thereof in such a way as to correspond to the rotation-preventing face 135 of the inner insertion tube body 130. In the first preferred embodiment of the present invention, the rotation-preventing retaining jaw portion 166 is flattened at a portion, which is in contact with the rotation-preventing face 135, in such a way as to correspond to the form of the rotation-preventing face 135.

Hereinafter, a process of disassembling the top nozzle from the guide thimble flange will be described.

First, the inner insertion tube head 140 is rotated to separate it from the inner insertion tube body 130. Thereafter, the top nozzle including the outer guide-tubular sleeves 120, the flow plate 160, hold-down springs (not shown) and the hold-down plate (not shown) is separated from the nuclear fuel assembly.

When each of the inner insertion tube heads 140 is separated from each of the inner insertion tube bodies 130, the screw-coupling between each inner insertion tube body 130 and each guide thimble flange 30 may be released.

However, by virtue of the rotation-preventing face portion 135 of the inner insertion tube body 130 and the rotation-preventing retaining jaw portion 166 of the flow plate 160, it is prevented that the inner insertion tube body 130 and the guide thimble flange 30 are separated from each other unintentionally.

In second and third preferred embodiments of the present invention, modifications of the rotation-preventing face portion of the inner insertion tube body and the rotation-preventing retaining jaw portion of the flow plate described in the first preferred embodiment will be described.

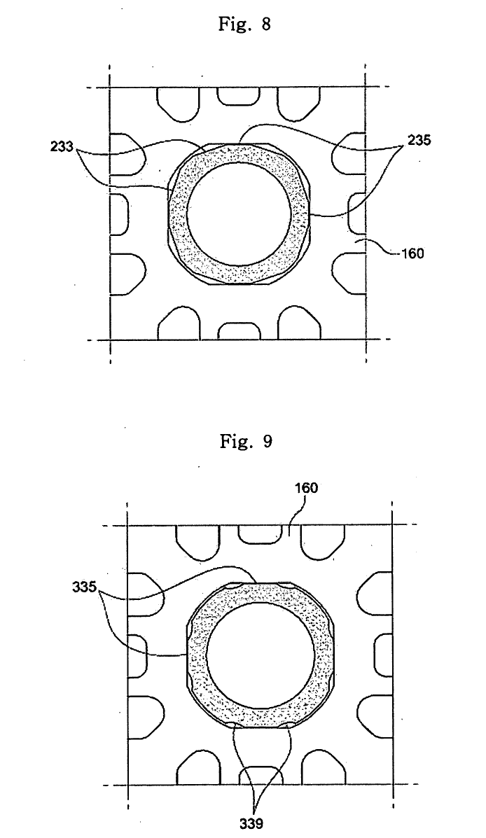

FIG. 8 is a bottom view showing a joining structure between a top nozzle and guide thimbles in a nuclear fuel assembly according to the second preferred embodiment of the present invention, wherein the inner insertion tube body having a plurality of rotation-preventing face portions is joined with the flow plate having a rotation-preventing retaining jaw formed in such a way as to correspond with the rotation-preventing face portions.

In the second and third preferred embodiments, guide portions for preventing interference when fuel rods are inserted longitudinally into and drawn out from the nuclear fuel assembly are disposed between the rotation-preventing face portions. The inner insertion tube body 130 according to the second preferred embodiment has guide faces 233, and the inner insertion tube body 130 according to the third preferred embodiment has guide recesses 339.

Each of the rotation-preventing face portion 235 of the inner insertion tube body 130 according to the second preferred embodiment has a plurality of faces, and each of the guide faces 233 is disposed between the rotation-preventing face portions 235 so as to prevent the interference when the fuel rods, which is adjacent to the guide thimbles inside spacer grids of the nuclear fuel assembly, are inserted longitudinally into or drawn out from the nuclear fuel assembly.

In more detail, the rotation-preventing face portions 235 of the second preferred embodiment are spaced apart from each other at intervals of 90°.

The rotation-preventing retaining jaw portion 266 of the flow plate 160, to which the inner insertion tube body 130 having the rotation-preventing face portions 235 is joined, is constructed of a form corresponding to the rotation-preventing face portions 235. The rotation-preventing retaining jaw portion 266 is flattened at a portion, which is in contact with the rotation-preventing face portions 235.

FIG. 9 is a bottom view showing a joining structure between a top nozzle and guide thimbles in a nuclear fuel assembly according to the third preferred embodiment of the present invention, wherein the inner insertion tube body having the guide recesses between the rotation-preventing face portions is joined with the flow plate.

Each of the rotation-preventing face portions 335 of the inner insertion tube body 130 according to the third preferred embodiment has a plurality of faces, and the rotation-preventing face portions 335 are spaced apart from each other at intervals of 90°.

Each of the guide recesses 339 is disposed between the rotation-preventing face portions 335, and performs the same role as each of the guide faces 233 of the second preferred embodiment. That is, the guide recesses 339 serve to prevent the interference when the fuel rods are inserted longitudinally into and drawn out from the nuclear fuel assembly. The guide recesses 339 are formed toward a central axis direction.

The third preferred embodiment may use the flow plate 160, to which the inner insertion tube body 130 is joined, used in the second preferred embodiment.

In the second and third preferred embodiments, when the flow plate 160 and the inner insertion tube body 130 are joined with each other, while the rotation-preventing face portions 235 and 335 are in contact with the flow plate 160, the guide faces 233 and the guide recesses 339 are spaced apart from the flow plate 160.

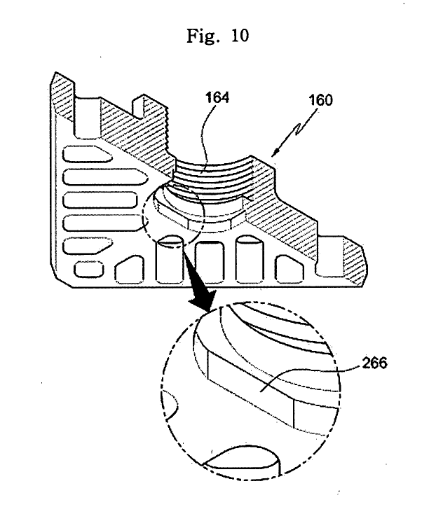

FIG. 10 is a perspective view, in section, of the flow plate, which may be used commonly in the second and third preferred embodiments. The flow plate 160 includes the through-hole 162, the female screw 164, and the rotation-preventing retaining jaw portion 266. Descriptions of the components of the flow plate 160 will be omitted since they are described in the first preferred embodiments.

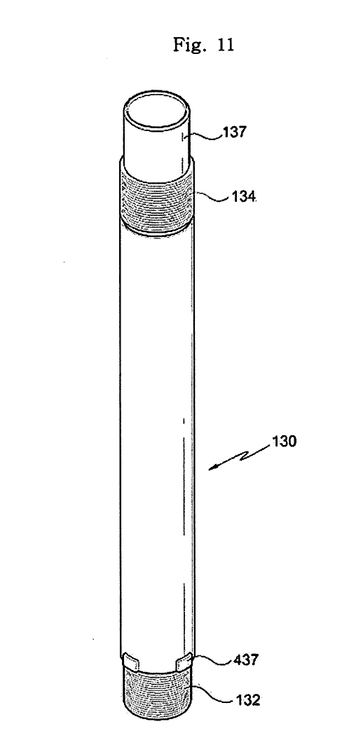

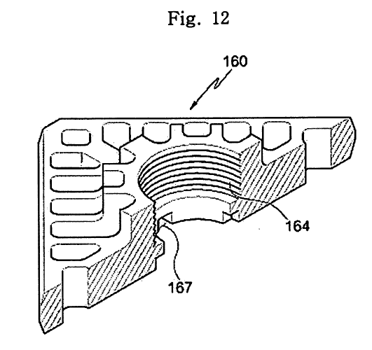

FIGS. 11 and 12 illustrate a fourth preferred embodiment of the present invention, which includes rotation-preventing means having rotation-preventing projections of the inner insertion tube body and rotation-preventing recesses of the flow plate. FIG. 11 is a perspective view of the inner insertion tube body having the rotation-preventing projections, and FIG. 12 is a perspective view, in section, of the flow plate having the rotation-preventing recesses.

That is, in the fourth preferred embodiment, the rotation-preventing projections 437 and the rotation-preventing recesses 167 are formed in place of the rotation-preventing face portions and the rotation-preventing retaining jaw portion of the first to third preferred embodiments.

The inner insertion tube body 130 has a plurality of the rotation-preventing projections 437 formed on the outer circumferential surface thereof, and the flow plate 160 has a plurality of the rotation-preventing recesses 167 corresponding to the rotation-preventing projections 437 as shown in FIG. 12.

Furthermore, in the fourth preferred embodiment, the inner insertion tube body 130 and the inner insertion tube head 140 may respectively have the screw guide portion 137 and the screw introduction portion 147.

That is, the screw guide portion 137 is formed above the upper male screw 134 of the inner insertion tube body 130, and has a smaller outer diameter than other portions of the inner insertion tube body 130 in such a way as to be easily joined with the inner insertion tube head 140.

Moreover, the screw introduction portion 147 is formed beneath the female screw 142 of the inner insertion tube head 140, and has a larger inner diameter than other portions of the inner insertion tube head 140 in such a way that the top of the inner insertion tube body 130 can be easily inserted thereto.

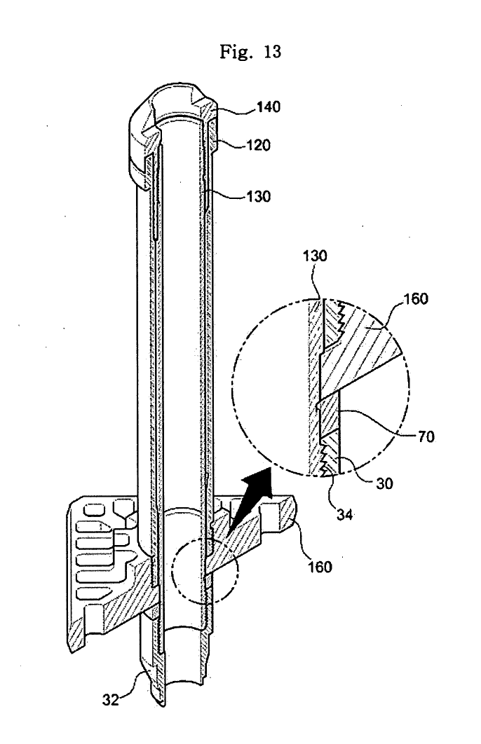

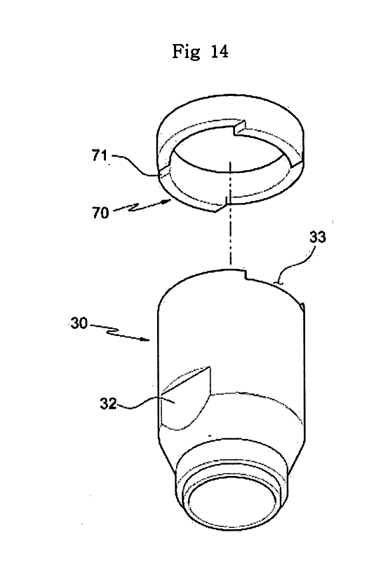

FIGS. 13 and 14 illustrate a fifth preferred embodiment of the present invention, wherein FIG. 13 is a perspective view, in section, showing a state where the outer guide-tubular sleeve, the inner insertion tube body, the inner insertion tube head, the wedge, the guide thimble flange and the flow plate are joined together, and FIG. 14 is a perspective view of the wedge and the guide thimble flange.

In the fifth preferred embodiment, in order to prevent a release of the screw-coupling between the inner insertion tube body 130 and the guide thimble flange 30, provided are the wedge 70, which is in contact with an upper portion of the lower male screw 132 of the inner insertion tube body 130 and includes at least one retaining jaw 71 extending from a portion of a lower end thereof, and the guide thimble flange 30 having at least one retaining jaw receiving portion 33 coupled with the retaining jaw 71 and having a shape corresponding to that of the retaining jaw 71.

The wedge 70 is formed of a short hollow cylinder, and has the retaining jaw 71 extending from one portion of the lower end thereof. It is preferable that the number of the retaining jaw 71 is decided in consideration of easiness or durability in manufacturing.

The retaining jaw receiving portion 33 having the shape corresponding to that of the retaining jaw 71 is formed on an outer circumferential surface of the upper portion of the guide thimble flange 30, which is joined with the wedge 70.

Furthermore, the guide thimble flange 30 has a tool contact portion 32 formed on a portion of an outer surface thereof to increase accessibility to tools.

Moreover, the guide thimble flange 30 has a female screw 34 formed on an inner circumferential surface thereof for a screw-coupling with the lower male screw 132 of the inner insertion tube body 130.

The upper portion of the lower male screw 132 of the inner insertion tube body 130, with which the wedge 70 is in contact, does not protrude outwardly as in the first to fourth preferred embodiments but has the same outer diameter as the inner insertion tube body 130.

Additionally, the inner insertion tube body 130 has the screw guide portion 137 formed above the upper male screw 134 thereof, and the screw guide portion 137 has the smaller outer diameter than other portions of the inner insertion tube body 130 so as to be easily joined with the inner insertion tube head 140.

The outer guide-tubular sleeve 120 and the inner insertion tube head 140 according to the fifth preferred embodiment have the same configuration as the first preferred embodiment.

An assembling process according to the fifth preferred embodiment of the present invention will be described as follows.

The wedge 70 is located and assembled between the lower male screw 132 of the inner insertion tube body 130 and the guide thimble flange 30, and then, welded and fixed to the inner insertion tube body 130.

The top nozzle including the outer guide-tubular sleeve 120, the hold-down spring (not shown) and the flow plate 160 is inserted into the inner insertion tube body 130, to which the wedge 70 is welded, and then, the inner insertion tube head 140 is joined and assembled to the upper portions of the inner insertion tube body 130 and the outer guide-tubular sleeve 120.

The forms of the rotation-preventing face portions 135, the rotation-preventing retaining jaw portion 166, the rotation-preventing projections 437 and the rotation-preventing recesses 167, which are the rotation-preventing means of various forms proposed in the first to fifth preferred embodiments, may adopt one of various forms having a plurality of faces to achieve the same object described in the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A joining structure between a top nozzle and guide thimbles in a nuclear fuel assembly comprising:
a guide thimble flange joined between an upper portion of each of the guide thimbles of the nuclear fuel assembly and a lower portion of the top nozzle;
the top nozzle comprising: a flow plate located above the guide thimble flanges and having a through-hole; outer guide-tubular sleeves, each of whose lower portion is joined to the through-hole of the flow plate; inner insertion tube bodies each adapted to be inserted into each outer guide-tubular sleeve, each of whose lower end portion protruding from a lower portion of the flow plate and being joined with each guide thimble flange; and inner insertion tube heads each adapted to be connected to upper end portions of each inner insertion tube body and each outer guide-tubular sleeve to thereby connect the inner insertion tube body and the outer guide-tubular sleeve with each other; and
rotation-preventing means disposed at a connected portion between the inner insertion tube body and the through-hole of the flow plate.

2. The joining structure according to claim 1, wherein the rotation-preventing means comprises:
rotation-preventing face portions formed on a portion of an outer circumferential surface of the inner insertion tube body in such a way as to flatten at least two faces; and
a rotation-preventing retaining jaw portion formed on an inner circumferential surface of the through-hole of the flow plate in such a way as to correspond to the rotation-preventing face portion.

3. The joining structure according to claim 2, wherein the rotation-preventing means further comprises a guide portion disposed between the rotation-preventing face portions to prevent interference when fuel rods are inserted longitudinally into or drawn out from the nuclear fuel assembly.

4. The joining structure according to claim 1, wherein the rotation-preventing means comprises:
at least one rotation-preventing projection formed on a portion of the outer circumferential surface of the inner insertion tube body; and
at least one rotation-preventing recess formed on the inner circumferential surface of the through-hole of the flow plate in such a way as to correspond to the rotation-preventing projection to allow the rotation-preventing projection to be joined thereto.

5. The joining structure according to claim 1, further comprising:
a screw introduction portion extending from a lower end of the inner insertion tube head and having a larger inner diameter than other portions of the inner insertion tube head; and
a screw guide portion extending from an upper end of the inner insertion tube body and having a smaller outer diameter than other portions of the inner insertion tube body.

6. A joining structure between a top nozzle and guide thimbles in a nuclear fuel assembly comprising:
a guide thimble flange joined with an upper portion of each of the guide thimbles of the nuclear fuel assembly and having a retaining jaw receiving portion; and
the top nozzle comprising: a flow plate located above the guide thimble flanges and having a through-hole; outer guide-tubular sleeves, each of whose lower portion is joined to the through-hole of the flow plate; inner insertion tube bodies each adapted to be inserted into each outer guide-tubular sleeve, each of whose lower end portion protruding from a lower portion of the flow plate and being joined with each guide thimble flange; inner insertion tube heads each adapted to be connected to upper end portions of each inner insertion tube body and each outer guide-tubular sleeve to thereby connect the inner insertion tube body and the outer guide-tubular sleeve with each other; and wedges each adapted to be joined to a lower portion of the flow plate and the inner insertion tube body, each of the wedges having at least one retaining jaw extending from a portion of a lower end thereof and joined with each of the guide thimble flanges in such a way as to be received in the retaining jaw receiving portion of the guide thimble flange.

7. The joining structure according to claim 6, further comprising:
a screw introduction portion extending from a lower end of the inner insertion tube head and having a larger inner diameter than other portions of the inner insertion tube head; and
a screw guide portion extending from an upper end of the inner insertion tube body and having a smaller outer diameter than other portions of the inner insertion tube body.

8. The joining structure according to claim 6, further comprising rotation-preventing means comprising:
rotation-preventing face portions formed on a portion of an outer circumferential surface of the inner insertion tube body in such a way as to flatten at least two faces; and
a rotation-preventing retaining jaw portion formed on an inner circumferential surface of the through-hole of the flow plate in such a way as to correspond to the rotation-preventing face portion.

9. The joining structure according to claim 2, further comprising:
a screw introduction portion extending from a lower end of the inner insertion tube head and having a larger inner diameter than other portions of the inner insertion tube head; and
a screw guide portion extending from an upper end of the inner insertion tube body and having a smaller outer diameter than other portions of the inner insertion tube body.

10. The joining structure according to claim 3, further comprising:
a screw introduction portion extending from a lower end of the inner insertion tube head and having a larger inner diameter than other portions of the inner insertion tube head; and
a screw guide portion extending from an upper end of the inner insertion tube body and having a smaller outer diameter than other portions of the inner insertion tube body.

11. The joining structure according to claim 4, further comprising:
a screw introduction portion extending from a lower end of the inner insertion tube head and having a larger inner diameter than other portions of the inner insertion tube head; and
a screw guide portion extending from an upper end of the inner insertion tube body and having a smaller outer diameter than other portions of the inner insertion tube body.

12. The joining structure according to claim 7, further comprising rotation-preventing means comprising:
rotation-preventing face portions formed on a portion of an outer circumferential surface of the inner insertion tube body in such a way as to flatten at least two faces; and
a rotation-preventing retaining jaw portion formed on an inner circumferential surface of the through-hole of the flow plate in such a way as to correspond to the rotation-preventing face portion.
